(19) United States
(12) Patent Application Publication
(10) Pub. No.: US 2026/0288451 A1
(43) Pub. Date: Sep. 24, 2026

(54) In-Service Software Downgrade

(71) Applicant: Mellanox Technologies, Ltd., Yokneam (IL)

(72) Inventors: Zachy Haramaty, Ramat-Gan (IL); Yair Chasdai, Tel Aviv (IL); Ido Zemah, Tel Aviv (IL); Ariel Jacob, Kiryat Tivon (IL); Oded Nadir, Ramat-Hashofet (IL); Amihay Tabul, Ness Ziona (IL); Nir Avital, Rosh Haayin (IL); Ori Varon, Ramat HaSharon (IL); Maty Golovaty, Tel Aviv (IL)

(21) Appl. No.: 19/084,820

(22) Filed: Mar. 20, 2025

(51) Int. Cl. G06F 8/656; G06F 8/71; G06F 11/3604

(52) U.S. Cl. CPC G06F 8/656; G06F 8/71; G06F 11/3604

(57) ABSTRACT

A computing device includes a memory and a processor. The memory is to store software. The processor is to receive an In-Service Software Downgrade (ISSD) request to downgrade the software from a high version to a low version. Responsively to the ISSD request, the processor is to identify one or more high-version-only software features that (i) are supported by the high version and not supported by the low version, and (ii) write one or more new values into one or more registers in a Control Register Space (CR-Space) of the processor, and to allow downgrading of the software only in response to verifying that the new values meet a defined downgradability criterion.

### FIELD OF THE INVENTION

The present invention, in exemplary embodiments thereof, relates to software downgrade, and particularly, but not exclusively, to in-service downgrade of software and/or firmware.

### BACKGROUND

In-service update generally refers to methods and techniques for updating software and firmware without taking a device on which the software / firmware runs offline during the software update. U.S. Patent 10,838,711, which is assigned to the assignee of the present disclosure, discloses a method, including altering the configuration of a system including a processor, firmware storage, and a scratchpad from a first configuration into a second configuration. The altering includes: A) re-configuring the system from the first configuration into an intermediate configuration in which the processor continues to run the first version of the firmware, B) disallowing at least one of a first plurality of operations, C) re-configuring the system from the intermediate configuration to the second configuration, and D) while the system is in the second configuration, allowing a second plurality of operations.

In-Service Software Downgrade (ISSD) (Software, in this context, includes Firmware) comprises reconfiguring the system from a high version to a lower version, disabling some or all the features that are supported in the higher version, without taking a device on which the software runs offline during the software downgrade (including, when needed, reconfiguring non-allowed values that the higher version may have programmed).

### SUMMARY

An embodiment that is described herein provides a computing device including a memory and a processor. The memory is to store software. The processor is to receive an In-Service Software Downgrade (ISSD) request to downgrade the software from a high version to a low version. Responsively to the ISSD request, the processor is to identify one or more high-version-only software features that (i) are supported by the high version and not supported by the low version, and (ii) write one or more new values into one or more registers in a Control Register Space (CR-Space) of the processor, and to allow downgrading of the software only in response to verifying that the new values meet a defined downgradability criterion.

In some embodiments, prior to identifying the high-version-only software features, the processor is to verify whether the high version meets a set of one or more ISSD compatibility criteria. In an example embodiment, one or more of the ISSD compatibility criteria verifies whether an In-Service-Software Upgrade (ISSU) from the low version to the high version is allowed.

In a disclosed embodiment, in verifying the downgradability criterion, the processor is to evaluate whether the new values are allowed values that (i) can be reverted to corresponding low-version values by the low version, and (ii) do not result in service interruption. In an example embodiment, upon finding a new value that is not an allowed value, the processor is to attempt changing the new value to an allowed value. The processor may, for example, attempt changing the new value by running an Application Program Interface (API) that requests the new value from a user. In another embodiment, the processor is to change the new value to a default value.

In some embodiments, the processor is to load the low version to the memory prior to handling the ISSD request, causing the low version to run upon reset. In an embodiment, prior to activating the low version, the processor is to run an ISSD-verification program that alerts upon detecting any of the high-only software features that prevent activation of the low version. Additionally, or alternatively, prior to activating the low version, the processor is to run an ISSD-verification program that, upon detecting a high-only software feature that prevents activation of the low version, corrects the detected high-only feature.

In a disclosed embodiment, the ISSD request instructs the processor to downgrade the software by more than one version, and, responsively to the ISSD request, the processor is to perform a sequence of in-service-downgrades, using at least one intermediate version between the high version and the low version.

There is additionally provided, in accordance with an embodiment that is described herein, a computing method including receiving an In-Service Software Downgrade (ISSD) request to downgrade software from a high version to a low version. Responsively to the ISSD request, one or more high-version-only software features are identified. The high-version-only software features (i) are supported by the high version and not supported by the low version, and (ii) write one or more new values into one or more registers in a Control Register Space (CR-Space) of the processor. Downgrading of the software is allowed only in response to verifying that the new values meet a defined downgradability criterion.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a Computing Device, in accordance with an embodiment that is disclosed herein;

FIG. 2 is a flowchart that schematically illustrates a method for In Service Software Downgrade (ISSD), in accordance with an embodiment that is disclosed herein;

FIG. 3 is a block diagram that schematically illustrates a network device, in accordance with an embodiment that is described herein; and

FIG. 4 is a block diagram that schematically illustrates a Computing System, e.g., a data center or a High-Performance Computing (HPC) cluster, in accordance with an embodiment that is described herein.

### DETAILED DESCRIPTION OF EMBODIMENTS

### Overview

The operating software of computing devices may be occasionally updated. The update typically comprises an upgrade from a lower, less capable version to a higher version that typically supports additional features; but sometimes may comprise a downgrade from the higher version to the lower version (we assume hereinbelow that the lower version supports a subset of the features that the higher version supports). In certain exemplary embodiments, such improved in-service update and/or upgrade may relate specifically to software (SW). In an embodiment, a lower-hierarchy processor runs low-level software, and a higher hierarchy processor that requests services from the lower hierarchy processor runs higher-hierarchy software.

Sometimes the computing device provides continuous service, where service interruptions are highly undesirable. For example, the computing device may be a router in a global network such as the Internet, or a node in a computing center. To allow software updates with minimal or no service interruptions, in-service updates (upgrades or downgrades) are used, which comprise methods and techniques for upgrading/downgrading the software without taking a device on which the software runs offline during the software update.

Embodiments that are disclosed below describe apparatuses and methods to downgrade a software version of a computing device, from a High-Version to a Low-Version, with no (or with minimal) service disruptions. As explained above, in the present context, firmware is also considered a type of software that can be downgraded using the disclosed techniques, and will be referred to as Software hereinbelow.

In an embodiment, prior to receiving an ISSD request, the computing device has loaded the low-version SW into an NVM. In response to an ISSD request, the computing device executes a series of operations, including: i) checking if ISSD is allowed (denying the ISSD request if ISSD is not allowed); ii) for every high-version-only software feature (that is, a feature that is supported in the high version and is not supported in the low version) that writes a value in a control register of the computing device, checking that the new value is an Allowed Value, and taking a Corrective Action if it is not; and, iii) booting from the low-version SW.

In some embodiments, Allowed Values of the control registers include any value that does not change a control register of the computing device to a value that is incompatible with the low-version and/or could disrupt the service that the computing device provides, and/or cannot be re-configured/disabled or monitored by the low version software

In a disclosed embodiment, the Corrective Action comprises asking the ISSD-requestor for an alternative value. In another embodiment, the Corrective Action comprises using a default value, and in yet another embodiment, there is no Corrective Action and the computing device, upon finding that an unallowed value has been written to a control register, denies the ISSD request.

Other embodiments are disclosed in the foregoing system description.

### System Description

When a computing device runs a high version of the operating software and receives a request to downgrade the software to a lower version, the computing device performs a series of operations that are designed to enable the downgrade according to a set of security rules and with minimal impact on the service that the computing device provides.

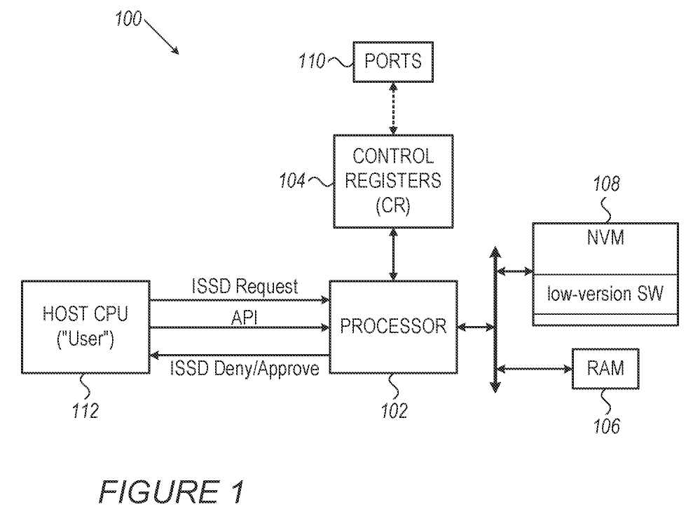

FIG. 1 is a block diagram that schematically illustrates a Computing Device 100, in accordance with an embodiment that is disclosed herein. The Computing Device comprises a Processor 102 to run software programs, Control Registers 104 (CR) to control the operation of the Computing Device, a Random-Access Memory (RAM) 106 to store data and programs, a Non-Volatile Memory (NVM) 108 to store data and program in a non-volatile medium, and Ports 110 to communicate with a communication network. In an embodiment, the processor writes and reads the ports using a dedicated CR address; thus, the ports are included in the CR-Space.

In some embodiments, RAM 106 and NVM 108 store computer programs and computer data. In some embodiments, the software is stored in NVM 108; in an embodiment, NVM 108 is a Flash memory.

If the Computing Device boots from the low-version SW, most of the high-version-only features that configure the hardware will remain, as they are not deactivated in the low-version SW. As a result, all the high-version features that configure the hardware and were activated when the high-version SW was configured (either during SW boot or pursuant to an ISSU operation) need to be explicitly disabled. (The low-version code that does not configure the hardware will be degraded when the low-version SW is booted.)

Computing Device 100 further comprises a Host CPU 112, which is also referred to as a User (in some embodiments, a human user communicates with Host CPU 112, e.g., through a keyboard, a screen and a mouse, that are not shown). Host CPU 112 runs SW, and requests the processor to execute tasks (e.g., communicate packets over a network).

Processor 102 may receive an ISSD request from the Host, to in-service-downgrade the software, from a high version to a low version. The Processor receives the ISSD request while it is running the high-version software. Assuming that the low-version software has been preloaded to the NVM, the processor responds to the ISSD request in four sequential stages.

At the first stage, the processor checks if the high-version is ISSD-compatible, according to a software ISSD set of compatibility criteria. If the high version is not ISSD compatible, the processor denies the ISSD request and continues high-version operation (the processor, in this case, will not enter the next stages).

At the second stage, the processor runs an ISSD SW that checks a list of high-version-only features (e.g., features that are supported by the high version and are not supported by the low version). As will be detailed below, the processor may, for each high-version-only feature, request the user to undo the feature (e.g., using an Application Programming Interface (API) that is typically provided with the high-version, through an API interface between the Host CPU and the Processor).

At the third stage, the processor verifies that there are no more high-only features remaining; and, at the fourth stage, the processor starts executing the low-version SW, e.g., by setting a program counter of the processor to point at the low-version SW in the NVM. In embodiments, the processor responds to the ISSD request by sending an ISSD Deny or an ISSD-Approve message to the requesting Host CPU.

It should be noted that, although the Computing Device continues to provide service throughout the four stages described above, service parameter settings (such as routing tables, performance metering, etc.) may not be updated during some of the stages; however, as the complete downgrade sequence is expected to consume not more than a few milliseconds, far less than the time constants associated with the parameters update, service continuity is virtually unaffected. To further reduce the downgrade sequence time, in some embodiments, prior to the first stage, the computing device runs a program that reverts some of the high-version-only features, e.g., features that have a reverting API, or, for which the reverting will not disrupt normal operation.

Examples of features that can be reverted at this stage- include:
1. Multicast SMAC mirroring (reverting is simple);
2. New Forward Error Correction (FEC) mode: to revert, the port has to be turned off, and, hence, reverting is not simple.
3. A feature for which a reverting API does not exist has been enabled by SW.

Thus, according to the example embodiment illustrated in FIG. 1 and described hereinabove, a Computing device responds to an ISSD request by sequentially checking and, if needed, modifying all the high-version-only features that are supported by the high version and not supported by the low version, and then running the low-version SW.

The configuration of Computing Device 100 described above is cited by way of example. Other configurations may be used in alternative embodiments. For example, in an embodiment, Computing Device 100 comprises a plurality of processors, of the same or of different types; some or all the processors may respond to the ISSD request.

### Writing unallowed values into the Cr-Space

The fourth stage of the ISSD procedure described above includes running the new low-version SW. However, some of the high-version-only features must be undone prior to this stage. In particular, features that write unallowed values to the CR-space should be disabled.

For example, if a high-version-only feature comprises setting a port to a new mode, the feature should be disabled or configured to values which the lower version can interpret.

In embodiments, the processor checks whether the new control register value meets one or more in service downgrade compatibility criteria.

### Bug -Compatibility

If a high-version-only feature comprises a fix of a bug in the low-version, the bug will be retained after the ISSD.

### Disabling Features Using Apis

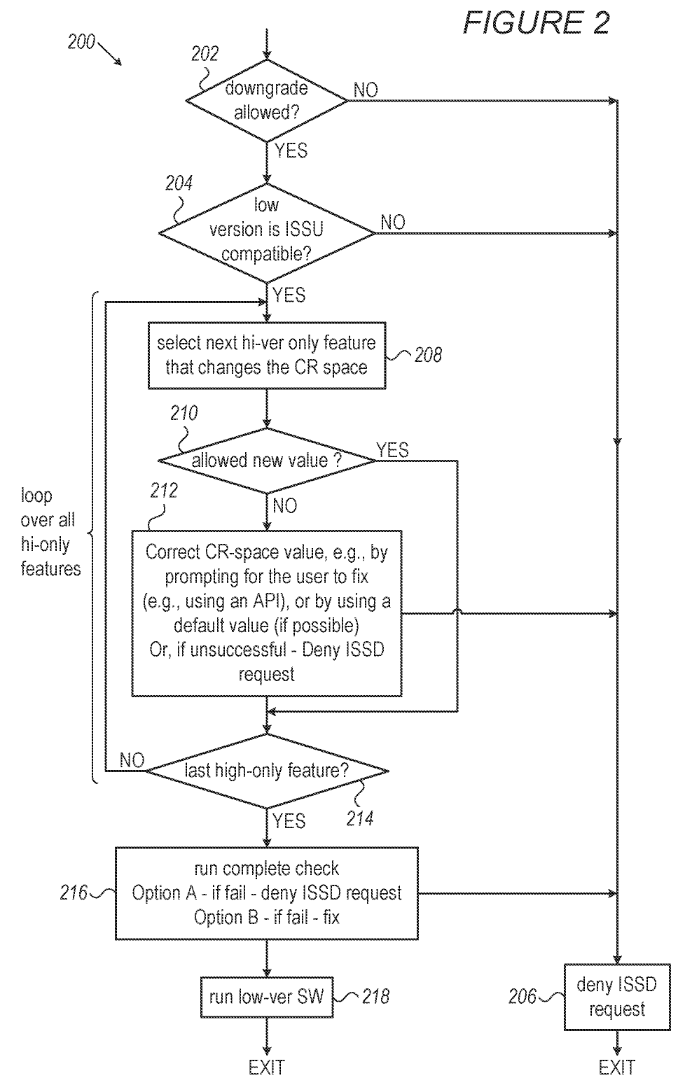

In some cases, to disable a high-version-only feature, the ISSD program executes a suitable Application-Programming Interface (API). In general, when the high-version-only feature code is developed, an API to undo the new feature is also developed, and provided as part of the high-version software package. An exemplary API will be presented below, with reference to FIG. 2.

In general, in some embodiments, any software change that does not affect the Cr-Space does not require any ISSD considerations. Examples:
1. The high-version includes a new assertion check that does not change the Cr-Space).
2. The high-version repairs a compilation warning (without changing the Cr-Space).
3. An input validation in the high-version is narrower (this does not directly change Cr-Space).
4. The high-version repairs software performance bugs (in this case the high-version and the low-version are logically equivalent).
5. Code size in the high-version is smaller than that of the low-version (in this case, too, the high-version and the low-version are logically equivalent).

FIG. 2 is a flowchart 200 that schematically illustrates a method for In-Service Software Degradation (ISSD) in a computing device, in accordance with an embodiment that is disclosed herein. The flowchart is executed by Processor 102, which runs software stored in RAM 106 (FIG. 1).

The flowchart starts at a Check-Downgrade-Allowed operation 202, wherein the processor checks whether downgrading from the current high version to a low version is allowed, by checking a set of downgrade compatibility criteria (also referred to as downgradability criteria). For example, in some cases, downgrading (in service or after reset) is not allowed, e.g., due to security limitations.

Next, at a Check-ISSU-Compatibility operation 204, the processor checks if the High Version is ISSU-compatible, that is, if an in-service upgrade from the low version to the high version can be done without interrupting the service. In embodiments, to allow ISSD from the high version to the low version, the low version must be ISSU-compatible.

If, in operation 202, downgrading is not allowed or, if, in operation 204, the low version is not ISSU-compatible, the processor enters a Deny-ISSD-Request operation 206, sends a Deny message to the user, and exits.

If, in operation 204, the low version is ISSU-compatible, the processor enters a loop in which the processor sequentially examines and handles all the high-version-only features. It should be noted that the high-version-only features include features that have been configured when the computing device was reset (with the high SW version stored in the NVM), features that were configured by an ISSU/ISSD process and that were enabled using APIs.

At a Select-Next-Feature operation 208, the processor selects the next high-version-only feature to be handled, beginning with the first high-version-only feature (the selected feature will be referred to hereinbelow as the current feature). Then, at a Check-Allowed-Value operation 210, the processor checks whether the new register value is allowed, by examining whether the new value meets a defined ISSD compatibility criterion. The term “allowed value” refers to any value that can be configured or interpreted by the low version.

If, in operation 210, the value in the CR register is not an allowed value, the processor will enter a Correct-Register-Value operation. In embodiments, operation 210 may include, for example, the following steps:
i) Prompting the user to enter an allowed value (e.g., using an API);
ii) If the user does not respond – using a predefined default value for the register, or, in an embodiment, enter operation 206 to deny the ISSD request;
iii) If a predefined value that does not disrupt normal operations exists – using the predefined value or, else, prompting the user for a new value.

Other courses of action to correct unallowed CR-Space register values, including (but not limited to) combinations of the steps described above, may be used in alternative embodiments. In some embodiments, the processor further checks whether the default value and/or the value provided by the user is an allowed value.

Further to operation 212 (unless operation 212 results in an ISSD-Denial), and further to an allowed value in operation 210, the processor enters a Check-Last-High-Only-Feature operation 214. If the current feature is not the last one, the processor will reenter operation 208, to handle the next high-version-only feature.

If, in operation 214, the processor finds that the last high-version-only feature has been handled, the processor enters a Run-Complete-Check operation 216, wherein the processor runs a program that rechecks that the current status of the system supports in-service downgrade and does not include high-version-only features that will not be disabled in the fourth stage (the term system, in the current context, refers to the contents of the memory and the registers of the Computing Device). This operation is, in a way, redundant, since the operations described hereinabove should guarantee a complete in-service downgrade; however, operation 216 may detect bugs in the former operations. Also, in some cases, we want to guarantee that the user will not, deliberately or accidentally, enter unallowed values.

Two alternative variants of Run-Complete-Check operation 216 are disclosed. In a first variant (Option A), the processor, responsively to a failed check, enters the Deny-ISSD-Request operation 208, sends a Deny-Request message to the user, and exits. In a second variant (Option B), the processor attempts to fix the failures and, if unsuccessful, enters the Deny-ISSD-Request operation 206 (“unsuccessful”, in the current context, refers to the case where a predefined substitute value, if written to the CR register, will disrupt normal operations. For example, a new port mode which can be disabled only when port is taken down).

If, in operation 216, the check is successful, the system is deemed ISSD-ready; the processor enters a Run-Low-Versions-SW operation 218, wherein the processor starts executing the low-version SW that has been preloaded into the NVM. ISSD is now successfully completed.

The configuration of flowchart 200, illustrated in FIG. 2 and described hereinabove, is cited by way of example. Other flowcharts may be used in alternative embodiments. For example, in some embodiments, Run-Complete-Check operation 216 is omitted.

### Multi-Version Downgrade

It may be required to downgrade the software by more than one version. In an embodiment, downgrade by multiple versions is done sequentially. The high-version SW includes code to downgrade sequentially, first to a previous version, and then, incrementally, to yet lower versions until the target low version is reached.

Obviously, if any of the intermediate versions has a bug which prevented ISSD, that bug should not be restored.

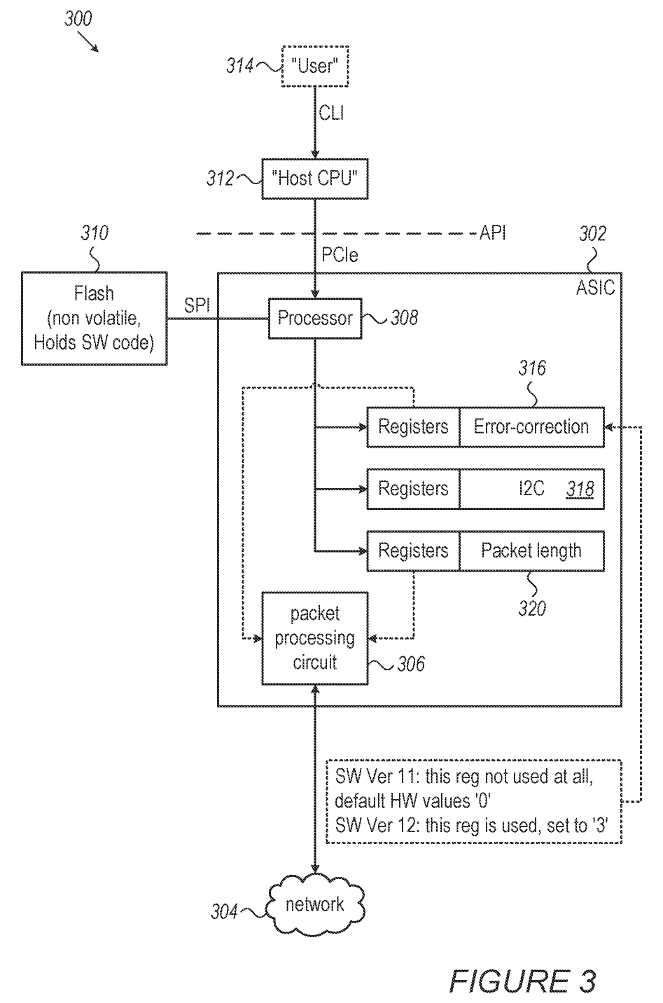

FIG. 3 is a block diagram that schematically illustrates a network device 300, in accordance with an embodiment that is described herein. Network Device 300 comprises a Switch 302 that communicates with a Switched Packet Network 304. The Switch comprises a Packet Processing Circuit 306 that handles packet switching, and a processor 308 that runs software including SW that is stored in an NVM (e.g., a Flash memory) 310. Processor 308 communicates through a bus (e.g., a Peripheral Component Interconnect Express, or PCIe bus) to a Host CPU 312 that is configured to run software, requesting network services from Switch 302. A User 314 (e.g., a human operator, or, in embodiments, a remote computer) may communicate with the Host CPU 312 using a Command Line Interface (CLI) (or, in embodiments, using a dialog-based interface).

Switch 302 may be providing network services to multiple clients. While Switch 302 provides the said service, User 314 may request that the Switch performs an ISSD, to degrade to a lower software version without disrupting the network services. In the example embodiment illustrated in FIG. 3, the current software version is designated 12, while the lower software version is designated 11.

Switch 302 further comprises CR-Space registers, including an Error-Correction register 316 which specifies the type of error correction to be used, an Inter-Integrated-Circuit (I2C) register 318 which specifies I2C parameters (e.g., I2C address), and a Packet-Length register 320, which specifies the maximum length of the egress packets. (The CR-Space registers described above comprise a non-binding example that is cited merely for the sake of clarity).

According to the example embodiment illustrated in FIG. 3, error correction is not supported in version 11, and, thus, Error-Correction register 316 should store the value of zero when the low-version is running. In version 12, however, an error correction algorithm designated “3” is supported and, hence, register 316 stores the value “3”.

In response to the ISSD request, the processor executes flowchart 200 (FIG. 2). In operation 212 (Correct CR-Space value), the processor will find out that no legal value is possible, because the processor may already be providing service that includes error correction; disabling error correction can only be done when there is no traffic on the corresponding port, and must be preceded by setting the port to a Down state, thus, disrupting the service. Therefore, the processor, in this case, will enter the Deny-ISSD-Request operation 206.

In another example, a change of the Packet Length is usually allowed, as the change may take place when the port is active.

The configuration of Network Device 300 illustrated in FIG. 3 and described hereinabove is cited by way of example. Other configurations may be used in alternative embodiments. For example, in some embodiments, Processor 308 communicates with Host 312 through a Universal Serial Bus (USB); in an embodiment, Switch 302 comprises the host CPU 312.

### Applications

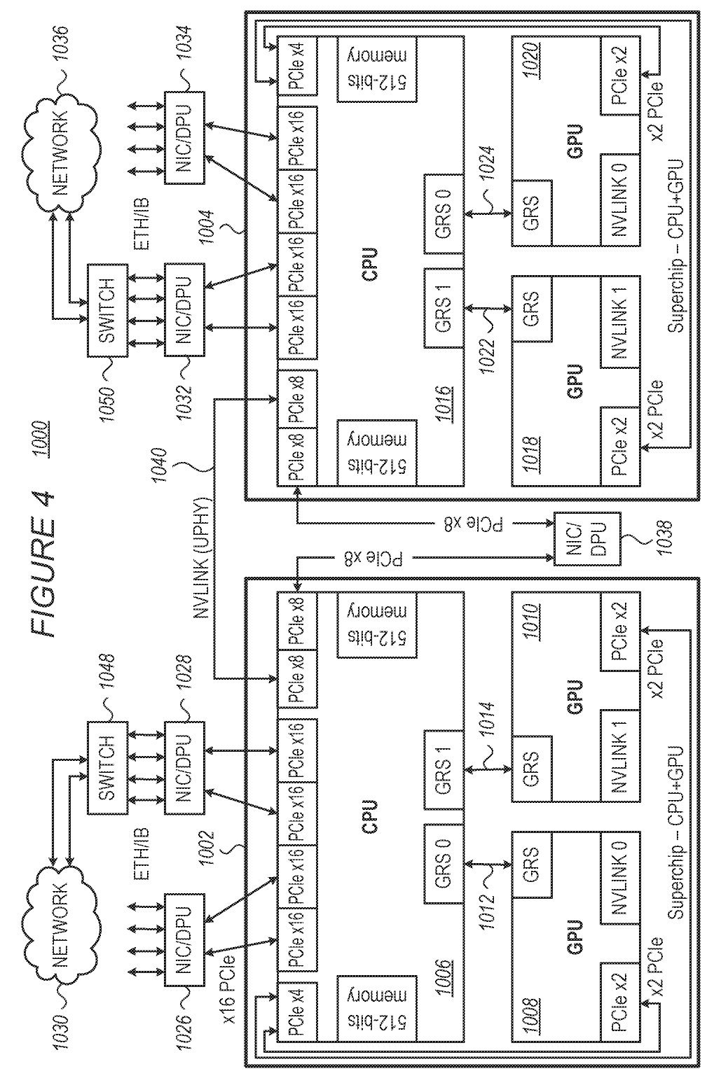

The techniques described above may be used in a variety of computing-device products, such as the computing system described below, with reference to FIG. 4.

FIG. 4 is a block diagram that schematically illustrates a Computing System 1000, e.g., a data center or a High-Performance Computing (HPC) cluster, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), wherein each integrated circuit can include one or more CPUs and GPUs, forming a powerful and flexible architecture. In embodiments, the various elements of Computing System 1000 may support ISSD as described above with reference to FIGS. 1 through 3.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 4 also demonstrates an example of a multi-GPU architecture. As illustrated in the figure, computing system 1000 includes a processing device 1002 with a multi-GPU architecture. In particular, processing device 1002 may be a system-on-chip and includes multiple subsystems, such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 4, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via a D2D or a C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 4, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communicate with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects.

In various embodiments, any of the network devices of system 1000, e.g., any of NICs/DPUs 1026, 1028, 1032, 1034, and 1038, and/or any of CPUs 1006, 1016, GPUs 1008, 1010, 1018, and 1020 may support in-service software downgrade (ISSSD), from a higher to a lower software version. The ISSD may be executed using the techniques described above, with reference to FIGS. 1, 2 and 3.

The apparatuses and methods described hereinabove, with reference to FIGS. 1, 2, 3 and 4, including the configuration of Flowchart 300 and including all units and subunits thereof, are example configurations and methods that are shown purely for the sake of conceptual clarity. Any other suitable methods and configurations can be used in alternative embodiments. For example, in some embodiments, the computing device may operate in a check-only mode, checking that all high-version-only features are allowed (that is, do not write into CR-Space registers, or write only allowed values); failure of any features will result in IDDS-denial. For another example, in some embodiments, operation 218 (FIG. 2) in which the computing device asks for an alternative CR-Space value in lieu of an illegal value can be done for all features that change a CR-Space value prior to the ISD sequence, to save the time in which no SW is active.

In various embodiments, ISSD may be implemented using suitable hardware, such as one or more Application-Specific Integrated Circuits (ASIC) or Field-Programmable Gate Arrays (FPGA), or a combination of ASIC and FPGA.

Processors 102 and 308 typically comprise a general-purpose computer, which is programmed in software to carry out the functions described herein. The software may be downloaded to the computer in electronic form, over a network, for example, or it may, alternatively or additionally, be provided and/or stored on non-transitory tangible media, such as magnetic, optical, or electronic memory.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A computing device, comprising:
a memory, to store software; and
a processor, to:
receive an In-Service Software Downgrade (ISSD) request to downgrade the software from a high version to a low version;
responsively to the ISSD request, identify one or more high-version-only software features that (i) are supported by the high version and not supported by the low version, and (ii) write one or more new values into one or more registers in a Control Register Space (CR-Space) of the processor; and
allow downgrading of the software only in response to verifying that the new values meet a defined downgradability criterion.

2. The computing device according to claim 1, wherein, prior to identifying the high-version-only software features, the processor is to verify whether the high version meets a set of one or more ISSD compatibility criteria.

3. The computing device according to claim 2, wherein one or more of the ISSD compatibility criteria verifies whether an In-Service-Software Upgrade (ISSU) from the low version to the high version is allowed.

4. The computing device according to claim 2, wherein, in verifying the downgradability criterion, the processor is to evaluate whether the new values are allowed values that (i) can be reverted to corresponding low-version values by the low version, and (ii) do not result in service interruption.

5. The computing device according to claim 4, wherein, upon finding a new value that is not an allowed value, the processor is to attempt changing the new value to an allowed value.

6. The computing device according to claim 5, wherein the processor is to attempt changing the new value by running an Application Program Interface (API) that requests the new value from a user.

7. The computing device according to claim 5, wherein the processor is to change the new value to a default value.

8. The computing device according to claim 1, wherein the processor is to load the low version to the memory prior to handling the ISSD request, causing the low version to run upon reset.

9. The computing device according to claim 1, wherein, prior to activating the low version, the processor is to run an ISSD-verification program that alerts upon detecting any of the high-only software features that prevent activation of the low version.

10. The computing device according to claim 1, wherein, prior to activating the low version, the processor is to run an ISSD-verification program that, upon detecting a high-only software feature that prevents activation of the low version, corrects the detected high-only feature.

11. The computing device according to claim 1, wherein the ISSD request instructs the processor to downgrade the software by more than one version, and wherein, responsively to the ISSD request, the processor is to perform a sequence of in-service-downgrades, using at least one intermediate version between the high version and the low version.

12. A computing method, comprising:
receiving an In-Service Software Downgrade (ISSD) request to downgrade software from a high version to a low version;
responsively to the ISSD request, identifying one or more high-version-only software features that (i) are supported by the high version and not supported by the low version, and (ii) write one or more new values into one or more registers in a Control Register Space (CR-Space) of the processor; and
allowing downgrading of the software only in response to verifying that the new values meet a defined downgradability criterion.

13. The method according to claim 12, further comprising, prior to identifying the high-version-only software features, verifying whether the high version meets a set of one or more ISSD compatibility criteria.

14. The method according to claim 13, wherein one or more of the ISSD compatibility criteria verifies whether an In-Service-Software Upgrade (ISSU) from the low version to the high version is allowed.

15. The method according to claim 13, wherein verifying the downgradability criterion comprises evaluating whether the new values are allowed values that (i) can be reverted to corresponding low-version values by the low version, and (ii) do not result in service interruption.

16. The method according to claim 15, and comprising, upon finding a new value that is not an allowed value, attempting changing the new value to an allowed value.

17. The method according to claim 16, wherein attempting changing the new value comprises running an Application Program Interface (API) that requests the new value from a user.

18. The method according to claim 16, wherein attempting changing the new value comprises changing the new value to a default value.

19. The method according to claim 1, further comprising loading the low version to memory prior to handling the ISSD request, causing the low version to run upon reset.

20. The method according to claim 12, further comprising, prior to activating the low version, running an ISSD-verification program that alerts upon detecting any of the high-only software features that prevent activation of the low version.

21. The method according to claim 12, further comprising, prior to activating the low version, running an ISSD-verification program that, upon detecting a high-only software feature that prevents activation of the low version, corrects the detected high-only feature.

22. The method according to claim 12, wherein the ISSD request instructs downgrading the software by more than one version, and comprising, responsively to the ISSD request, performing a sequence of in-service-downgrades, using at least one intermediate version between the high version and the low version.
